(19) United States
(12) Patent Application Publication
(10) Pub. No.: US 2010/0228864 A1
(43) Pub. Date: Sep. 9, 2010

(54) SERIAL DEVICE MANAGEMENT SYSTEM

(75) Inventor: Mohammad Arif, Phoenix, AZ (US)

Correspondence Address: SNELL & WILMER L.L.P. (Main), 400 EAST VAN BUREN, ONE ARIZONA CENTER, PHOENIX, AZ, 85004-2202, US

(73) Assignee: HYPERCOM CORPORATION, Scottsdale, AZ (US)

(21) Appl. No.: 12/681,563

(22) PCT Filed: Oct. 3, 2008
(86) PCT No.: PCT/US08/78831

§ 371 Date: Apr. 2, 2010

(30) Foreign Application Priority Data
Oct. 4, 2007 (US) 60977578

(51) Int. Cl. G06F 15/16

(52) U.S. Cl. 709/227

(57) ABSTRACT

The serial device management system is a new and innovative method of aiding the deployment and troubleshooting of POS terminals serially connected to IP enabled devices. Various messages and other data may be sent through a pipe from the IP enabled device to a serially connected POS terminal. This will allow the POS terminal to behave as if it has a direct IP connection.

### FIELD OF INVENTION

The present invention relates generally, to interaction with and management of a device that is connected to a network via a serial connection.

### BACKGROUND OF THE INVENTION

Point of service (“POS”) terminals enable convenient electronic payment for many products and services. Consumers holding cards associated with a charge, credit, debit, or loyalty account may pay for a purchase simply by entering a card or card information directly into the POS terminal. The demonstrated success of “pay at the pump” terminals is just one example of the popular acceptance of and preference for the convenience of POS terminal transactions. Smart card and contactless card readers provide additional convenience at such POS terminals.

Presently known POS terminals typically include, inter alia, a magnetic stripe reader, a keypad for entry of a personal identification number (“PIN”), and a user display. Conventional POS terminals communicate either directly or indirectly with a central computer to authorize and settle sales transactions. POS terminals are often peripheral devices to another device such as an electronic cash register (ECR). In such configurations, the POS device will typically use a serial connection such as RS232 and Universal Serial Bus (USB) to connect to the ECR.

However, this configuration with a serial connection is limited. For example, currently known techniques cannot automatically detect POS terminals that are part of the POS infrastructure without utilizing extra hardware equipment or software. In addition, further problems are presented by the use of proprietary non-standard communication protocols that typically block other processes that need to use the same serial port. Also, the use of devices with serial communication connections alone, generally prohibit their management over local area networks (LANs), wide area networks (WANs) or the Internet, unless the devices are designed to use IP enabled protocols such as point-to-point protocol (PPP). Although using a protocol such as PPP might provide IP over a serial line (e.g., used for serial modems to access the internet through an ISP), the customer's ECR application would have to be modified to support the PPP protocol. The serial-to-IP proxy provided by the present invention, allows IP connectivity for devices using a serial connection such as RS-232 or USB to an IP enable PC, without the need to change any of the customer's software or device configuration.

As a result of this situation, in order to provide an improved solution for a serially connected POS terminal, and to lower the support costs associated with serially connected POS terminals, a novel and non-obvious serial device management system for POS terminals is described below.

### BRIEF DESCRIPTION THE DRAWINGS

The drawings described herein are for illustration purposes only and are not intended to limit the scope of the present disclosure in any way. The present invention will become more fully understood from the detailed description and the accompanying drawings wherein:

FIG. 1 illustrates an IP enabled device and a POS device according to various embodiments of the present invention; and

FIG. 2 illustrates various IP services in a serial-to-IP proxy system in accordance with various embodiments of the present invention.

### DETAILED DESCRIPTION

The following description is of certain exemplary embodiments of the present invention only, and is not intended to limit the scope, applicability or configuration of the invention. Rather, the following description is intended to provide a convenient illustration for implementing various embodiments of the invention. As will become apparent, various changes may be made in the function and arrangement of the elements described in these embodiments without limiting or diminishing the scope of the invention as set forth herein. It should be appreciated that the description herein may be adapted to be employed with alternatively configured devices having different shapes, components, materials and the like and still fall within the scope of the present invention. Thus, the detailed description herein is presented for purposes of illustration only and not of limitation. For example, the steps recited in any of the method or process descriptions may be executed in any order and are not limited to the order presented.

For the sake of brevity, conventional data networking, application development and other functional aspects of the system (and components of the individual operating components of the system) may not be described in detail herein. It should be noted that many alternative or additional functional relationships or physical connections may be present in a practical system.

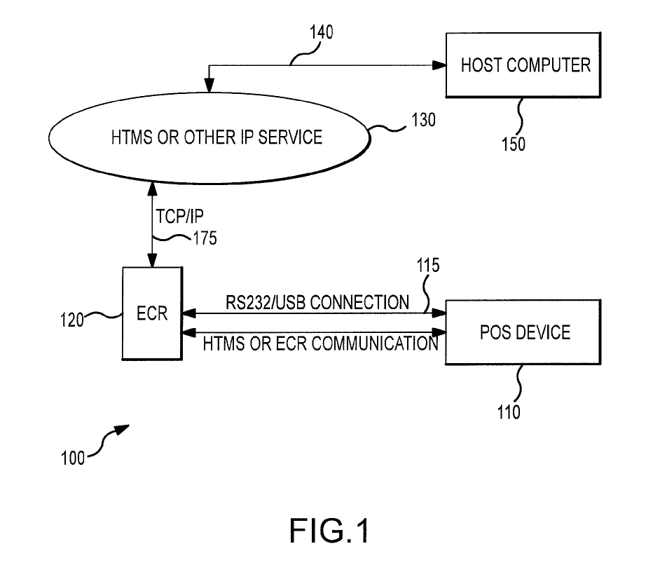

With reference to FIG. 1, a block diagram of one exemplary embodiment of a system 100 to facilitate the deployment and troubleshooting of serial connected POS terminals 110. POS terminal 110 may be any device, software, and/or component(s) suitably configured to facilitate a commercial transaction between a merchant and a customer utilizing a transaction instrument (e.g., credit card, debit card, charge card, smart card, and the like). Thus, POS terminal 110 may be any POS terminal known in the art or developed in the future. In accordance with an aspect of one exemplary embodiment of the invention, POS terminal 110 is an Optimum L4100 terminal manufactured by Hypercom Corporation of Phoenix, Ariz., although any POS terminal manufactured by Hypercom Corporation is certainly contemplated by the invention. In accordance with another aspect of the present invention, POS terminal 110 may be a personal identification number (PIN) pad that is controlled by an electronic cash register (ECR).

POS terminal 110, according to various embodiments of the invention, includes a transaction instrument reader (e.g., magnetic stripe reader, a smart card reader, a radio frequency reader, and the like); various electronic circuits for processing a commercial transaction; a housing for the POS terminal; and user interface components including one or more of the following: a display for presenting and/or receiving transaction information; and a keypad including numeric, alphanumeric, and/or function keys. POS terminal 110 may be used with any number of transaction instruments, and thus, may provide for interchangeable or supplemental transaction instrument interfaces. For example, in one embodiment, a magnetic stripe reader module may be detached from POS terminal 110 housing and a smart card reader module attached to the housing in its place. Wireless capabilities may also be incorporated into POS terminal 110 to provide portability. Periphery devices for use with POS terminal 110 may include printers, additional displays, personal identification number (PIN) entry pads, alphanumeric keyboards, voice prompt systems, signature capture devices, bar code reader, and biometric reader.

In addition, POS terminal 110 includes a terminal identifier such that POS terminal 110 may be identified as the POS terminal that made a purchase when a user utilizes POS terminal 110 to purchase applications. In accordance with an aspect of one exemplary embodiment, the terminal identifier may be a serial number assigned to POS terminal 110 that is unique across multiple POS terminal populations (i.e., industries). In another aspect of the invention, the terminal identifier may be a digital signature that POS terminal 110 utilizes to identify itself when downloading and/or purchasing applications and/or demonstration applications.

Furthermore, POS terminal 110 can be used in conjunction with any type of personal computer, network computer, workstation, minicomputer, mainframe, or the like running any operating system such as any version of Windows, Windows XP, Windows NT, Windows 2000, Windows 98, Windows 95, MacOS, OS/2, BeOS, Linux, UNIX, Solaris, or the like. Moreover, although the invention is implemented with TCP/IP (Transmission Control Protocol/Internet Protocol) or Point-to-Point Protocol (PPP) communications protocols, it will be readily understood that the invention could also be implemented using IPX, Appletalk, IP-6, NetBIOS, OSI, or any number of existing or future protocols. Moreover, the system contemplates the use, sale, or distribution of any goods, services, or information over any network having similar functionality described herein.

POS terminal 110, in one exemplary embodiment, is connected to an IP enabled device 120, such as an electronic cash register (ECR), via a network connection 115, wherein network connection 115 may be any software and/or hardware component(s) suitably configured to facilitate electronic communications between POS terminal 110 and device 120. In accordance with one embodiment of the present invention, network connection 115 suitably comprises a serial connection such as a RS-232 or USB connection. Exemplary devices 120 also include Ethernet devices such as a router, hub, switch, modem, cable modem, or other similar devices. In accordance with other embodiments of the present invention, other types of networks and devices may be used to connect to POS terminal 110.

In accordance with one embodiment of the present invention, access to the Internet 130 is facilitated via communication channels 125. Exemplary networks or communication channels 125 include, but are certainly not limited to, a telephone network (i.e., dial-up network), an extranet, an intranet, the Internet, online communications, satellite communications, off-line communications, wireless communications, transponder communications, a local area network (LAN), a wide area network (WAN), networked or linked devices, and/or any suitable communication or data input modality.

In the illustrated implementation, network 130 is embodied as the Internet and is presumed to be insecure and open to eavesdroppers. In this context, POS terminal 110 and/or any computing devices (e.g., Ethernet device 120) may or may not be connected to the Internet at all times. Specific information related to the protocols, standards, and application software utilized in connection with the Internet may not be discussed herein. For further information regarding such details, see, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997). LOSHIN, TCP/IP CLEARLY EXPLAINED (1997), all of which are hereby incorporated by reference.

System 100, in one exemplary embodiment, also includes a central or host computer 150 that is connected to network 140. Host computer 150 may be any computing device and/or system that facilitates the processing and authorization of a transaction that is initiated at POS terminal 110. Host computer 150 may be in the form of a network computer, a workstation, a server, a minicomputer, a mainframe computer, a personal computer, a laptop, a notebook, a hand held computer, a set-top box, and the like. Host computer 150 may include other servers or other computing systems including a processor for processing digital data, a memory connected to the processor for storing digital data, an input digitizer connected to the processor for inputting digital data, an application program stored in the memory and accessible by the processor for directing processing of digital data by the processor, a display connected to the processor and memory for displaying information derived from digital data processed by the processor, and one or more databases, each database suitably including client data, merchant data, host institution data, and/or like data that could be used in association with the present invention. As those skilled in the art will appreciate, host computer 150 will typically include an operating system (e.g., Windows XP, NT, 95/98/2000, Linux, Solaris, and the like) as well as various conventional support software and drivers typically associated with computers.

The present invention provides for a serial device management system that is a new and innovative method and system of aiding the deployment and troubleshooting of POS terminals that are serially connected to IP enabled devices. In accordance with one aspect of the present invention, the system allows data and messages to be sent through a pipe from various IP services through an IP enabled device to the serially connected payment device. It will be appreciated that the payment device will behave as if it has a direct IP connection to those services. The services can send data and messages to an IP enabled device directly or indirectly through a similar “pipe” to that of the serial connection proxy. Advantages for this are that all services can be designed for IP connectivity and will still be able to interact with serial (RS-232 or USB) enabled as well as IP enabled payment terminals. Currently, customers use a provided application to communicate with their payment device through a serial connection. This application will now contain the additional serial-to-proxy functionality.

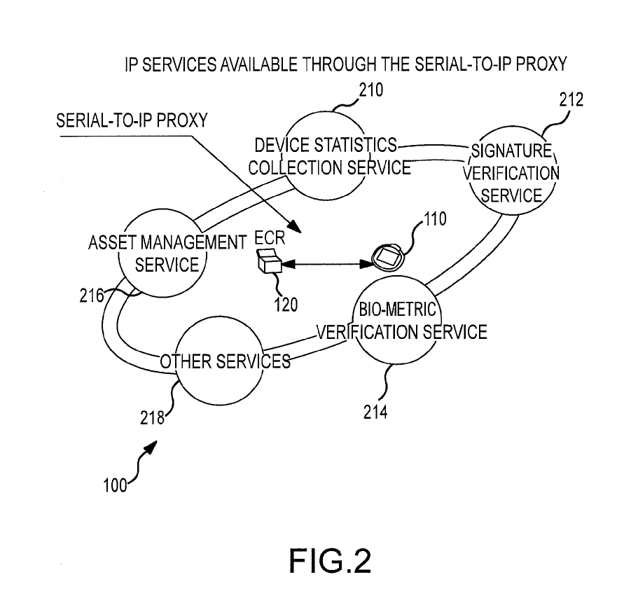

With reference to FIG. 2, IP services may include a device statistics collection service 210, a signature verification service 212, a bio-metric verification service 214, an asset management service 216, and other services 218. The IP Services may be located in the IP enabled device 120, such as an electronic cash register. In an another embodiment of the present invention, the some or all of the IP services may be located in a separate computer that is in communication with IP enabled device 120. For example, this separate computer may be a central computer that is in communication with multiple POS devices 110 via multiple IP enabled devices 120. In accordance with one aspect of the present invention, the separate computer may be located at a site that is remote from IP enabled device 120 and POS terminal 110.

In accordance with an embodiment of the present invention, with reference to FIG. 2, serial-to-IP proxy may run on the Microsoft Windows platform, such as on IP enabled device 120 or on the separate computer (such as a personal computer or computer server) connected to the IP enabled device. The serial-to-IP proxy enables an IP service or application to be designed for IP connectivity, but to still be able to interact with serial enabled (such as RS-232 or USB) and IP enabled POS terminals. The serial-to-IP proxy facilitates this communication by converting the IP messages to messages for the serial connection, and vice versa.

POS terminals 110 may be auto-detected on the local area network and information on the detected POS terminals may be provided to the system administrator or other user of the network. This will enable the user to choose files to be transferred from a personal computer or IP enabled device 120 to a specific POS terminal, all POS terminals, or to a subset of POS terminals in the network.

When it is necessary to add or replace an IP service, the additional or replacement IP service may be simply located on the IP enabled device 120 or the separate computer, without the need for certification of the IP service. Thus, it is possible to have multiple POS applications or IP services on IP enabled device 120 that communicate with POS device 110. It should be appreciated that this reduces the cost of recertification, such as payment card industry (PCI) certification, for the applications.

The present invention has been described above with reference to an exemplary embodiment. However, those skilled in the art will recognize that changes and modifications may be made to the exemplary embodiment without departing from the scope of the present invention. For example, the various processing steps dictated by the present invention, as well as the components for carrying out the processing steps, may be implemented in alternate ways depending upon the particular application or in consideration of any number of cost functions associated with the operation of the system. These and other changes or modifications are intended to be included within the scope of the present invention.

What is claimed is:

1. A method of interacting with a payment device, the method comprising:
connecting the payment device to an internet protocol (IP) enabled device via a network connection;
locating an IP enabled service on the IP enabled device, wherein the IP enabled service is designed for IP connectivity;
communicating from the IP enabled service to the payment device, via the network connection, wherein the network connection is a serial network connection; and
wherein the communicating from the IP enabled service to the serial connected payment device is via a serial-to-IP proxy.

2. The method of claim 1, wherein the network connection comprises an RS-232 connection.

3. The method of claim 1, wherein the network connection comprises a universal serial bus (USB) connection.
